(19) United States
(12) Patent Application Publication
(10) Pub. No.: US 2008/0243603 A1
(43) Pub. Date: Oct. 2, 2008

(54) PROVIDING PRODUCT PLACEMENT INFORMATION PRESENTED IN A MEDIA PROGRAM

(76) Inventors: Salina Sau-Yue Chu, Austin, TX (US); Dustin C. Kirkland, Austin, TX (US); Ameet M. Paranjape, Cedar Park, TX (US)

Correspondence Address: IBM CORP (YA);C/O YEE & ASSOCIATES PC, P.O. BOX 802333, DALLAS, TX, 75380, US

(21) Appl. No.: 11/692,963

(22) Filed: Mar. 29, 2007

(51) Int. Cl. G06Q 30/00

(52) U.S. Cl. 705/14

(57) ABSTRACT

A method, an apparatus, and a computer usable program product for providing product placement information presented in a media program is provided. A controller receives a request for the product placement information presented in the media program. In response to receiving the request, the controller captures a timeframe for the request for the media program, wherein a product placement information list is associated with the timeframe. The controller then extracts the product placement information list for the timeframe from a buffer associated with the media program. The controller then presents the product placement information list to a user.

### BACKGROUND OF THE INVENTION

1. Field of the Invention

The present invention relates generally to an improved media device, and more specifically to a product presented on a media device. Still more specifically, the present invention relates to a method, an apparatus, and a computer usable program product for providing product placement information presented in a media program.

2. Description of the Related Art

Advertisers commonly place products in a television program or movie as one way of advertising the product. For example, International Business Machines (IBM®) may place a laptop computer in a particular television show so that viewers can see the laptop computer when the show is presented. The advertising vehicle of including a product in a media program is called product placement.

However, many times, viewers see the presented product in the media program but do not know how to purchase the product. For example, a viewer may see a sofa or clothing outfit presented on the media program but, later, is not able to locate or find the same item in a local retail establishment. Furthermore, viewers often may see a product and be interested in the product when presented, but later forget the details relating to the product as soon as the product is out of sight.

### SUMMARY OF THE INVENTION

A method, an apparatus, and a computer usable program product for providing product placement information presented in a media program is provided. A controller receives a request for the product placement information presented in the media program. In response to receiving the request, the controller captures a timeframe for the request for the media program, wherein a product placement information list is associated with the timeframe. The controller then extracts the product placement information list for the timeframe from a buffer associated with the media program. The controller then presents the product placement information list to a user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram of a digital video recorder in which illustrative embodiments may be implemented;

FIG. 4 is a data processing system for combining product placement information in a media program, in accordance with an illustrative embodiment;

FIG. 5 illustrates a digital video recorder, in accordance with an illustrative embodiment;

FIG. 6 is an example product placement information list for a timeframe for a media program, in accordance with an illustrative embodiment;

FIG. 7 illustrates an example product placement list, in accordance with an illustrative embodiment;

FIG. 8 depicts an example image of a media program and the product placement information presented on the media program, in accordance with an illustrative embodiment; and

FIG. 9 is a flowchart illustrating the process of providing product placement information presented in a media program, in accordance with an illustrative embodiment.

### DETAILED DESCRIPTION OF THE PREFERRED EMBODIMENT

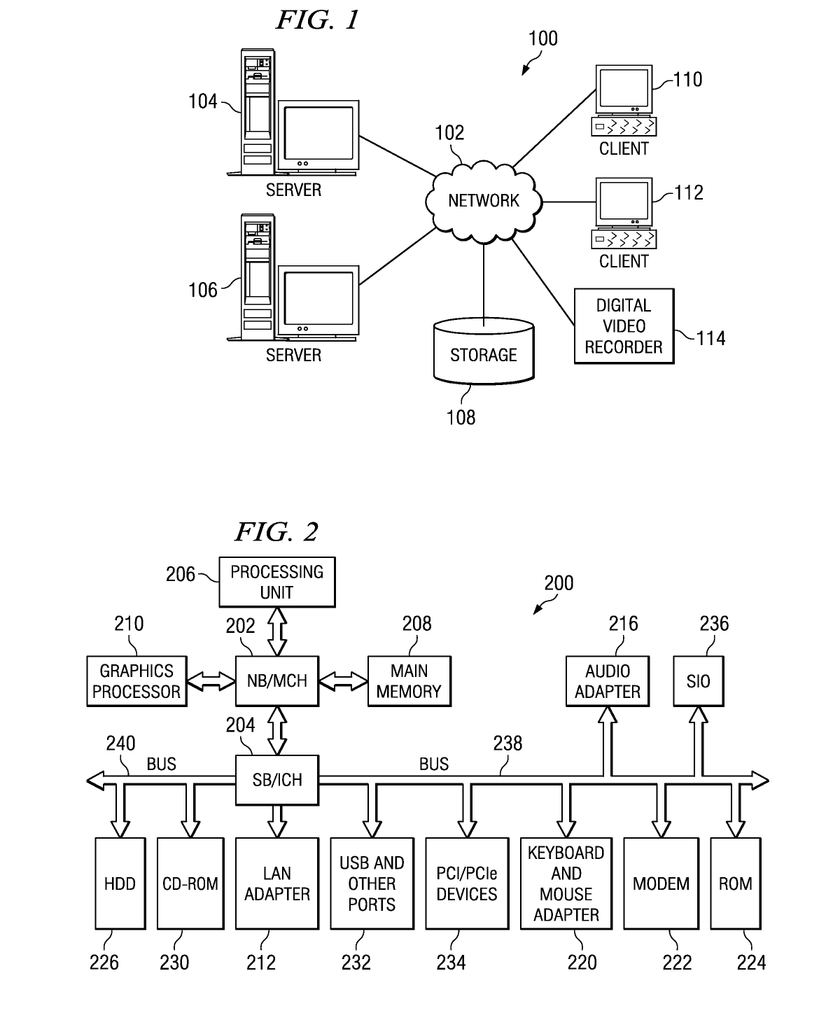

With reference now to the figures and in particular with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110 and 112 connect to network 102. Clients 110 and 112 may be, for example, personal computers or network computers. In the depicted example, server 104 provides data, such as boot files, operating system images, and applications to clients 110, 112, and 114. Clients 110 and 112 are clients to server 104 in this example. Network data processing system 100 may include additional servers, clients, and other devices not shown.

In the depicted example, digital video recorder 114 connects to network 102. Digital video recorder 114 is any device that manages media programs, such as a television program, a commercial, an infomercial, a music video, or a streaming video. A media program is a program presented via a media device, including but not limited to a television, a radio, a personal digital assistant (PDA), a wireless mobile device, and a computer.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

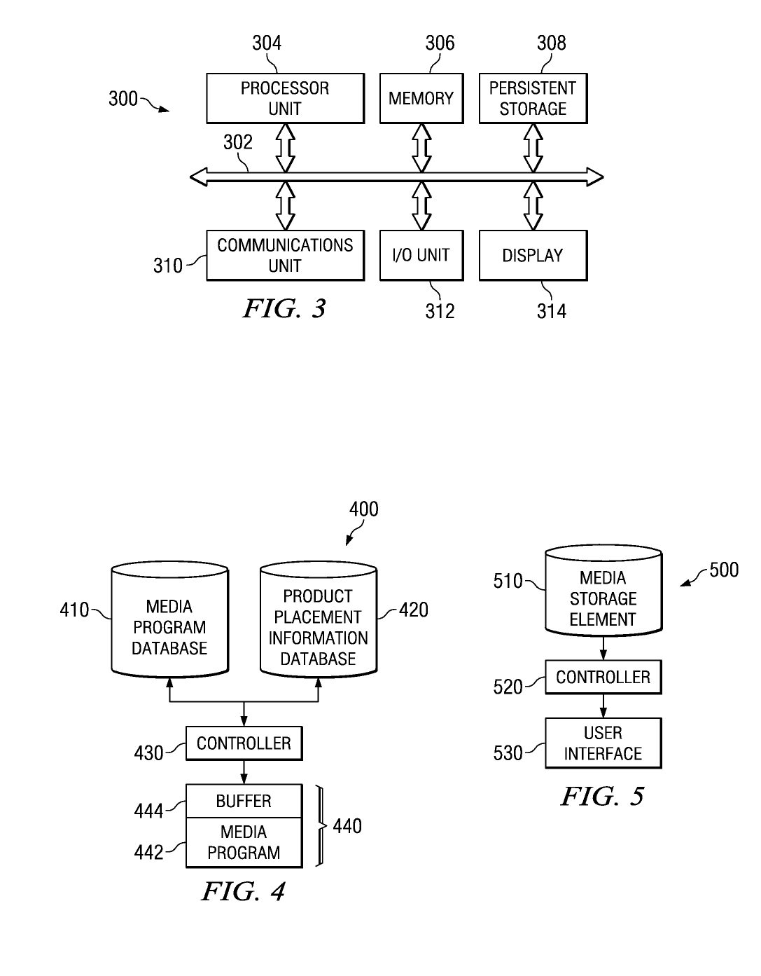

Turning now to FIG. 3, a block diagram of a digital video recorder is depicted in which illustrative embodiments may be implemented. In this illustrative example, the digital video recorder is similar to digital video recorder 114 of FIG. 1.

In this illustrative example, digital video recorder 300 includes communications fabric 302, which provides communications between processor unit 304, memory 306, persistent storage 308, communications unit 310, input/output (I/O) unit 312, and display 314.

Processor unit 304 serves to execute instructions for software that may be loaded into memory 306. Processor unit 304 may be a set of one or more processors or may be a multi-processor core, depending on the particular implementation. Further, processor unit 306 may be implemented using one or more heterogeneous processor systems in which a main processor is present with secondary processors on a single chip. Memory 306, in these examples, may be, for example, a random access memory. Persistent storage 308 may take various forms depending on the particular implementation. For example, persistent storage 308 may be, for example, a hard drive, a flash memory, a rewritable optical disk, a rewritable magnetic tape, or some combination of the above.

Communications unit 310, in these examples, provides for communications with other data processing systems or devices. In these examples, communications unit 310 is a network interface card. I/O unit 312 allows for input and output of data with other devices that may be connected to digital video recorder 300. For example, I/O unit 312 may provide a connection for data input through a television cable line. Further, I/O unit 312 may send output to a television set or other similar media device. Display 314 provides a mechanism to display information to a user.

Instructions for the operating system and applications or programs are located on persistent storage 308. These instructions may be loaded into memory 306 for execution by processor unit 304. The processes of the different embodiments may be performed by processor unit 304 using computer implemented instructions, which may be located in a memory, such as memory 306.

The illustrative embodiments provide a method, an apparatus, and a computer usable program product for providing product placement information presented in a media program. A controller receives a request for the product placement information presented in the media program. A media program is any program broadcasted by a media outlet, such as a television or radio station. Example media programs include a television show, a radio program, a music video, a commercial, an infomercial, or a streaming video.

The request is an interrupt signal initiated by a predetermined set of actions. The predetermined set of actions can be the pressing of a key, an audible command, a recognizable gesture, or any combination thereof. The predetermined set of actions can be a single action or a series of actions. If the predetermined set of actions is the pressing of a key, the key can be a specifically designated key, a key currently existing on a keypad, or a code that can be punched into a keypad. If the predetermined set of actions is an audible command, the audible command can originate from a device or a human being. If the predetermined set of actions is a recognizable gesture, the recognizable gesture can be any physical action that can be detected by the remote control or the media device itself.

In response to receiving the request, the controller captures a timeframe for the request for the media program. The timeframe is a time period for a particular media program. The time period can be a single point in time or length of time, and can be determined based on the media program. If based on the media program, the timeframe can be divided into any segment within the media program, such as a portion of a chapter, an entire chapter, or several chapters.

A product placement information list is associated with the timeframe. The product placement information is information needed by a user to purchase the referenced product. The product placement information can include at least one of a name of a manufacturer, a cost of the product, a store location to purchase the product, an internet address for the product, and an email address for the manufacturer of the product.

A product placement information list is stored in a buffer attached to the data used in the media program presented to the user. The product placement information list can be a single product or more products. The product placement information list is extracted from the buffer and presented to the user. In one embodiment, only the product placement information list is presented to the user. In another embodiment, the product placement information list and a captured image are both presented to the user.

In one embodiment, the controller visually presents the product placement information list on a media device. The media device can be a television, a radio, a computer, a personal digital assistant, or any other wireless mobile device. In another embodiment, the controller audibly presents the product placement information list through the media device. In yet another embodiment, the controller transmits the product placement information list to a user specified device. In this embodiment, the controller transmits the list via an electronic mail message. The user specified device can be a data processing system, a computer, a personal digital assistant, or a wireless mobile device. In this embodiment, the product placement information includes a link to an internet address for purchasing a product presented in the media program.

FIG. 4 is a data processing system for combining product placement information in a media program, in accordance with an illustrative embodiment. Data processing system 400 manages all media programs and the corresponding product placement information for at least one media outlet. A media outlet is any organization that presents media programs. Example media outlets include a television or radio station. A media program is any program presented via a media device. Example programs include a television show, a radio program, a music video, a commercial, an infomercial, or a streaming video. Example media devices include a television, radio, computer, personal digital assistant (PDA), or any wireless mobile device. In the illustrative embodiment, data processing system 400 manages the media programs from a television station.

Data processing system 400 includes media program database 410, product placement information database 420, controller 430, and combined media program 440. Data processing system 400 can be implemented as server 104 or 106 of FIG. 1, or as data processing system 200 of FIG. 2. All components within data processing system 400 are combined software and hardware embodiments. However, in alternative embodiments, the components can be a software-only embodiment or a hardware-only embodiment.

Media program database 410 and product placement information database 420 store all the media programming and corresponding product placement information, respectively, for data processing system 400. Media program database 410 and product placement information database 420 are storage elements which can be implemented in a memory, such as main memory 208 of FIG. 2, or hard disk drive, such as hard disk drive 226 of FIG. 2. In the illustrative embodiment, media program database 312 in FIG. 3 stores the media programs in a flat file in the hard disk drive, while product placement information database 420 stores all the product placement information in a table in the hard disk drive.

Product placement information database 420 stores information regarding a particular product that is presented in a media program. In the illustrative embodiment, a product is any item that can be purchased in a retail environment, such as a grocery item, clothing, furniture, or technical equipment.

Product placement information database 420 also includes purchase information regarding the products placed in a media program. Any information about the product can be included in product placement information database 420, including but not limited to the name of the product, the manufacturer's name, the name and address of the closest retail outlet that sells the particular item, and the email address or webpage address for the manufacturer or the retail outlet. In the illustrative embodiment, product placement information database 420 stores the information in a table.

Controller 430 connects to media program database 410, product placement information database 420, and combined media program 440. Controller 320 of FIG. 3 can be implemented in a processor unit, similar to processing unit 206 of FIG. 2. Controller 430 combines the product placement information stored in product placement information database 420 with a particular media program stored in media program database 410. To combine related, controller 430 inserts the product placement information into a data buffer in the data stream for a particular media program. The result of the combination is illustrated as combined media program 440, illustrated herein as the combination of buffer 444 and media program 442. A data buffer, such as data buffer 444, is a memory or storage element connected to or associated with a data stream, such as media program 442. In the illustrative embodiment, data buffer 444 is a data element that runs parallel with media program 442. In an alternative media program 442 is broken into segments and data buffer 444 is inserted in between the corresponding segments.

After the product placement information is inserted into the data stream, controller 430 transmits the media program with the inserted product placement information to a media device for broadcasting to a user. By inserting the product placement information in the data stream, the inserted information is hidden in the data stream. Thus, the product placement information is not presented when the media program is presented to a user. Only when a particular instruction requesting the product placement information is initiated will the information be presented to the user.

The illustrative embodiment is not limited to the illustrated example. For example, data processing system 400 can include more or fewer components. Additionally, controller 430 can insert data into a data stream in any other method known in the art without deviating from the scope of the project. Additionally, all the information for a product stored in product placement information database 420 does not necessarily need to be inserted into the data stream. The media outlet or the administrator of data processing system 400 can limit the amount and type of product placement information inserted into data buffer 444.

FIG. 5 illustrates a digital video recorder, in accordance with an illustrative embodiment. Digital video recorder 500 is a device that manages media programs for a particular user. Digital video recorder 500 can be implemented as digital video recorder 114 of FIG. 1 or digital video recorder 300 of FIG. 3. In the illustrative embodiment, digital video recorder 500 includes media storage element 510, controller 520, and user interface 530. All components within digital video recorder 500 are combined software and hardware embodiments. However, in alternative embodiments, the components can be a software-only embodiment or a hardware-only embodiment.

Media storage element 510 is a storage element which can be implemented in a memory, such as memory 306 of FIG. 3, or persistent storage, such as persistent storage 308 of FIG. 3, of digital video recorder 500. Media storage element 510 can store data in any format, including but not limited to a table, a flat file, an extensible Markup Language (XML) file, a relational database management system, or any combination thereof. In the illustrative embodiment, media storage element 510 stores media programs as a flat file in persistent storage.

Media storage element 510 stores the media programs presented to a user via digital video recorder 500. The media program stored can be a prerecorded media program or a media program that is currently being presented to a user. A prerecorded media program is a media program in which a user identifies and instructs digital video recorder 500 to save and record. Media storage element 510 saves the prerecorded media program until the user is ready to watch the media program or until the user designates that the media program to be erased.

In the illustrative embodiment, digital video recorder 500 includes the capability of capturing a timeframe for a particular media program when product placement information is requested by a user. A timeframe is a specific time in a media program in which a product placement information list is associated or linked. In other words, for every segment or period of time in a media program, a product placement information list is linked with the corresponding segment or period of time. The timeframe can be any period of time, including but not limited to a specific time, a period of time covering a chapter in the media program, or a segment that covers more or less than a chapter in the media program. The timeframe can be established by a default setting or established by the manufacturer or user of digital video recorder 500.

The product placement information list can include information about one or more than one particular product. Typically, the product placement information list corresponds to the product which is being presented to a user via digital video recorder 500. However, alternatively, even when the product is no longer being presented, the product information for the product placement information can still be stored in media storage element 510 for the timeframe. Additionally, the product placement information list can be static or dynamic. Thus, the specific products within the product placement information list can change over time or remain constant throughout the entire media program.

Media storage element 510 stores both the media program and the product placement information corresponding to the media program. Thus, media storage element 510 stores the combined media program, similar to combined media program 440 of FIG. 4. Digital video recorder 500 presents the combined media program to a user, but when presented, the product placement information is hidden and not presented until requested by the user.

Controller 520 manages requests for the product placement information. Controller 520 connects to storage device 510 and user interface 530. Controller 520 can be implemented in a processor unit, similar to processor unit 304 of FIG. 3.

User interface 530 is a component that allows a user to request product placement information presented in a media program. User interface 530 can be a remote control, a keypad on digital video recorder 114 of FIG. 1, a browser in a data processing system, or a dial or keypad on a radio unit. In the illustrative embodiment, user interface 530 is a remote control for digital video recorder 114 of FIG. 1.

In use, a user initiates a request for product placement information by performing a predetermined set of actions on user interface 530. The predetermined set of actions can be a default setting or selected by the user. The predetermined set of actions can be a single action or a series of actions performed using a remote control or the keypad of digital video recorder 500. In one embodiment, the predetermined set of actions is a designated key on a remote control or digital video recorder keypad. The key can be a specific key named “product placement information” or any other similar key. Alternatively, the key can be a standard button or number on the keypad, such as the pause button, the pound key, the asterisk key, or a number key. The key can also be a code or a series of characters and numbers. In an alternative embodiment, the predetermined set of actions can be an audible command. The audible command can be originated from a device or from a human being. Example audible commands include a tone, a whistle, a clap, or specific word from a human voice. The audible command can be a series of audible commands and can be in a distinct pattern. For example, the distinct pattern can be two quick claps and then a third clap after a few seconds. In yet another embodiment, the predetermined set of actions can be a recognizable gesture. A recognizable gesture is a movement that is recognized by the receiving device. For example, the recognizable gesture can be the continuous waving of a remote control over a period of time. Another example recognizable gesture is the waving of a hand in front of an infrared sensor embedded in digital video recorder 500. In the illustrative embodiment, the predetermined set of actions is a hitting of the pause button.

When a user executes the predetermined action or set of actions, user interface 530 transmits an interrupt signal to controller 520. An interrupt signal is an asynchronous signal indicating a need for change in the execution of a set of instructions. Thus, in the illustrative embodiment, the interrupt signal indicates the need to change the normal transmission of a media program. Specifically, the interrupt signal indicates that a timeframe for a media program presented by digital video recorder 500 needs to be captured.

Controller 520 determines the appropriate timeframe that needs to be captured by establishing the time when the user initiated the predetermined set of actions. After determining the timeframe, controller 520 then identifies the product placement information list associated with the particular timeframe. Controller 520 then identifies and extracts the product placement information list from the buffer and presents the product placement information to the user. In one embodiment, controller 520 visually presents the product placement information to the user on the display for the media device. In another embodiment, controller 520 can audibly present the product placement information to the user. In yet another embodiment, controller 520 both audibly and visually presents the product placement information to the user. In still yet another embodiment, controller 520 transmits the product placement information to a user specified device, such as a computer, PDA, or wireless mobile device. In this embodiment, controller 520 can also transmit an image of the media program that matches the captured timeframe. In other words, controller 520 transmits the image presented on digital video recorder 500 at the time the user initiated the predetermined set of actions. Controller 520 can transmit the information to the user in the form of an electronic mail (email) message. The email can include both the image and product placement information as an attachment or have both inserted into the message directly. Alternatively, the email can also include a hyperlink that transfers the user to another website that includes the information.

The illustrative embodiments are not limited to the illustrative example. For example, digital video recorder 500 can include more or fewer components. Furthermore, the illustrative embodiment can be implemented in any device which presents media programs, such as a television set, a radio, a video recorder, a PDA, a computer, or any other wireless mobile device.

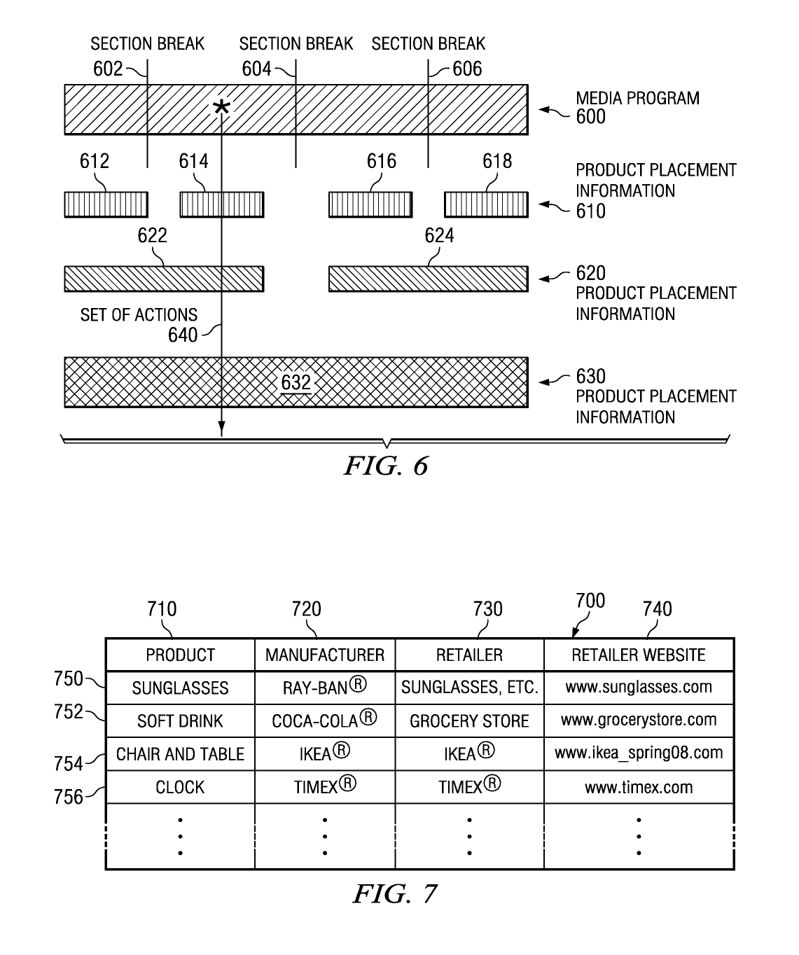

FIG. 6 is an example product placement information list for a timeframe for a media program, in accordance with an illustrative embodiment. The illustrative embodiment can be implemented in a media device, similar to digital video recorder 500 of FIG. 5.

In the illustrative embodiment, media program 600 is a television show separated into four sections. Each section is separated by section break 602, 604, and 606. Depending on implementation, each section can represent a number of portions of media program 600, including but not limited to a chapter, a portion of a chapter, or several chapters of media program 600. Each section can also be a single media program or several media programs if media program 600 represents a series of media programs. Furthermore, each section can be a period of time. In the illustrative embodiment, each section is a chapter of media program 600.

In the illustrative embodiment, section breaks 602, 604, and 606 can be commercial or non-commercial breaks. If a commercial break, section breaks 602, 604, and 606 can represent a period of time in which a set of commercials is presented. A set of commercials can be one or more commercials. If a non-commercial break, section breaks 602, 604, and 606 are breaks depending on implementation as discussed above. In the illustrative embodiment, section breaks 602, 604, and 606 are non-commercial breaks.

Product placement information 610, 620, and 630 represents information for separate products. Product placement information is stored in the buffer of a combined media program, similar to data buffer 444 of combined media program 440 of FIG. 4. Product placement information 610, 620, and 630 can represent a single product or a list of products. Product placement information 610, 620, and 630 are associated with a timeframe of media program 600.

Each product placement information 610, 620, and 630 has different established timeframes associated with media program 600. Thus, in the illustrative embodiment, product placement information 610 is associated with four timeframes, 612, 614, 616, and 618, for media program 600. Therefore, in use, if a user initiates a request at any time period in which timeframes 612, 614, 616, and 618 are associated with media program 600, then product placement information 610 will be presented to the user. Similarly, product placement information 620 includes timeframes 622 and 624, and a controller will present information to a user if timeframes 622 and 624 are associated with media program 600 at the particular timeframe. Product placement information 630 includes timeframe 632 runs the entire length of media program 600. Therefore, product placement information 630 will always be presented to the user anytime the user initiates a request.

Set of actions 640 is the predetermined set of actions that initiates a request for product placement information. Set of actions 640 can be the pressing of a key, an audible command, or a recognizable gesture. In the illustrative embodiment, set of actions 640 is the pressing of a pause button.

In the illustrative embodiment, set of actions 640 is initiated between section breaks 602 and 604. During that time period, timeframes 614, 622, and 632 are associated with media program 600. Therefore, at the time that the user initiated set of actions 640, product placement information 610, 620, and 630 will be presented to the user.

The illustrative embodiments are not limited to the illustrated example. For example, more or fewer product placement information can be included with media program 600. Additionally, media program 600 can be divided into more or fewer sections and include more or fewer section breaks. Moreover, set of actions 640 can occur at any time period when media program 600 is presented to a user. Furthermore, media program 600 can be presented on any media device. Additionally, instead of running parallel with media program 600, product placement information 610, 620, and 630 can be in a buffer inserted at different points in media program 600.

FIG. 7 illustrates an example product placement list, in accordance with an illustrative embodiment. Table 700 can be implemented in a product placement information database, similar to product placement information database 420 of FIG. 4. Table 700 is a list of products presented in a timeframe associated with a media program, specifically, in the illustrative embodiment, in a television program.

Table 700 includes product column 710, manufacturer column 720, retailer column 730, and retailer website column 740. Product column 710 lists the products associated with the timeframe for the media program. Manufacturer column 720 lists the manufacturer for the respective product listed in product column 710. Retailer column 730 is the name of the retail establishment or business entity which sells the particular product. Retailer website column 740 is a world wide web (WWW) address for the retail establishment listed in column 730.

Lines 750 through 756 list four products which were presented in the image of the media program. Line 750 indicates that a pair of “Ray-ban® sunglasses” was presented. Ray-ban® is a registered trademark of Bausch & Lomb, Inc. in the United States, other countries, or both. The sunglasses can be purchased at “Sunglasses, etc.” whose website is “www.sunglasses.com”. Line 752 indicates that a “soft drink” by “Coca-Cola®” was presented. Coca-Cola® is a registered trademark of The Coca-Cola Corporation in the United States, other countries, or both. The user can purchase the soft drink at “Grocery Store” whose website is “www.grocerystore.com”. Line 754 indicates that the image includes a “chair & table” from “IKEA®” whose website is “www.ikea_spring08.com”. IKEA® is a registered trademark of IKEA Systems in the United States, other countries, or both. Line 756 indicates that the image also includes a “Timex® clock” which can be purchased at “www.timex.com”. Timex® is a registered trademark of Timex Corporation in the United States, other countries, or both.

The illustrative embodiment is not limited to the illustrated example. For example, table 700 can include other columns, such as the address and phone number of the retailer listed in line 730. Additionally, each product listed in product column 710 can have more than one manufacturer and/or retailer. Furthermore, more or less products can be included in table 700.

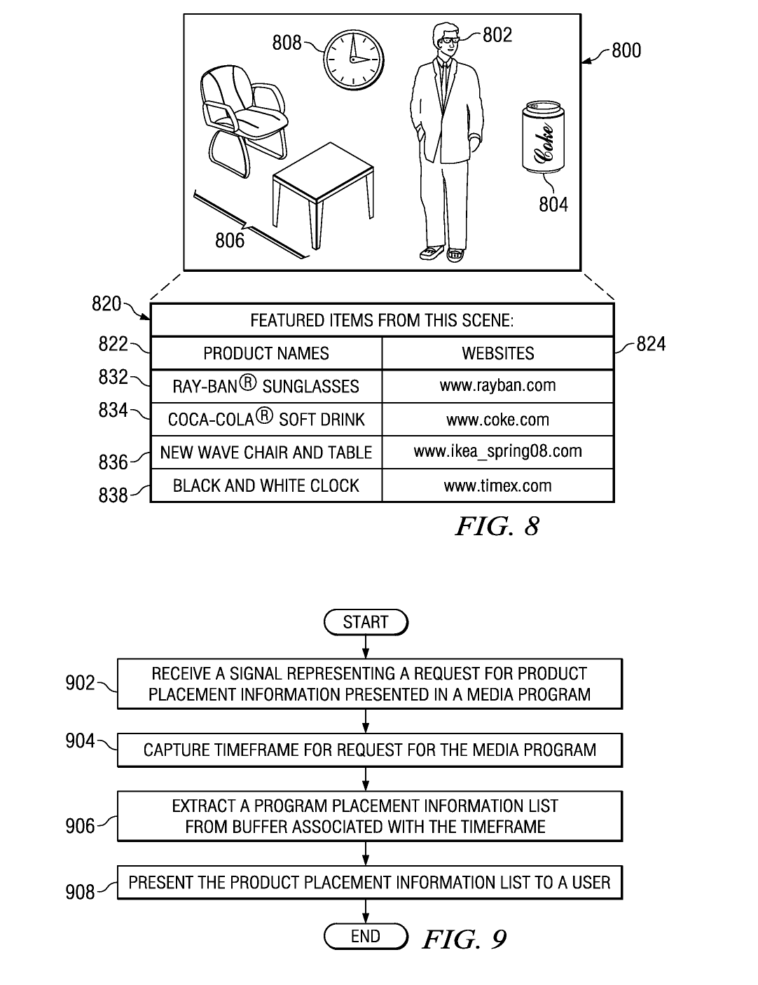

FIG. 8 depicts an example image of a media program and the product placement information presented on the media program, in accordance with an illustrative embodiment. Timeframe 800 can be implemented using digital video recorder 500 of FIG. 5 and is associated with a particular media program. In the illustrative embodiment, timeframe 800 is a screen shot or image of a television program. Timeframe 800 includes sunglasses 802, soft drink 804, chair and table set 806, and clock 808.

Window 820 illustrates the “featured items from this scene” or the product placement information for the products featured in timeframe 800. Window 820 includes two lists: product names list 822 and websites list 824. Product names list 822 lists the products featured in timeframe 800, and websites list 824 identifies the corresponding website for the product listed in product names list 822.

In the illustrative embodiment, sunglasses 802 is presented in line 832 as “Ray-ban® sunglasses” with a corresponding website of “www.rayban.com”. Line 834 indicates that soft drink 804 is a “Coca-Cola® soft drink” which can be found at “www.coke.com”. Chair and table set 806 is listed in line 836 as “New wave chair and table” which can be purchased at “www.IKEA_spring08.com”. Line 838 indicates that clock 808 is a “black and white clock” located at “www.timex.com”.

The illustrative embodiments are not limited to the illustrated example. For example, timeframe 800 can include more or fewer products. Additionally, instead of presenting the information in a separate window, the product placement information can be presented immediately beside the product in timeframe 800. Alternatively, the product placement information can be included in timeframe 800 in any other format, such as a scrolling banner or popup window. Additionally, product placement information can be transmitted to the user via an electronic mail (email) message.

FIG. 9 is a flowchart illustrating the process of providing product placement information presented in a media program, in accordance with an illustrative embodiment. The process can be implemented in a controller for a digital video recorder, similar to controller 520 of FIG. 5. The following process is exemplary only and the order of the steps may be interchanged without deviating from the scope of the invention.

The process begins when a controller receives a signal representing a request for product placement information presented in a media program (step 902). The controller then captures a timeframe for a request for the media program (step 904). The controller then extracts a product placement information list from the buffer associated with the timeframe (step 906). The controller then presents the product placement information list to a user (step 908), with the process terminating thereafter.

Thus, the illustrative embodiments provide a method, an apparatus, and a computer usable program product for providing product placement information presented in a media program. A controller receives a request for the product placement information presented in the media program. A media program is any program broadcasted by a media outlet, such as a television or radio station. Example media programs include a television show, a radio program, a music video, a commercial, an infomercial, or a streaming video.

The request is an interrupt signal initiated by a predetermined set of actions. The predetermined set of actions can be the pressing of a key, an audible command, a recognizable gesture, or any combination thereof. The predetermined set of actions can be a single action or a series of actions. If the predetermined set of actions is the pressing of a key, the key can be a specifically designated key, a key currently existing on a keypad, or a code that can be punched into a keypad. If the predetermined set of actions is an audible command, the audible command can originate from a device or a human being. If the predetermined set of actions is a recognizable gesture, the recognizable gesture can be any physical action that can be detected by the remote control or the media device itself.

In response to receiving the request, the controller captures a timeframe for the request for the media program. The timeframe is a time period for a particular media program. The time period can be a single point in time or length of time, and can be determined based on the media program. If based on the media program, the timeframe can be divided into any segment within the media program, such as a portion of a chapter, an entire chapter, or several chapters.

A product placement information list is associated with the timeframe. The product placement information is information needed by a user to purchase the referenced product. The product placement information can include at least one of a name of a manufacturer, a cost of the product, a store location to purchase the product, an internet address for the product, and an email address for the manufacturer of the product.

A product placement information list is stored in a buffer attached to the data used in presented the media program to the user. The product placement information list can be a single or more products. The product placement information list is extracted from the buffer and presented to the user. In one embodiment, only the product placement information list is presented to the user. In another embodiment, the product placement information list and a captured image are both presented to the user.

In one embodiment, the controller visually presents the product placement information list on a media device. The media device can be a television, a radio, a computer, a personal digital assistant, or any other wireless mobile device. In another embodiment, the controller audibly presents the product placement information list through the media device. In yet another embodiment, the controller transmits the product placement information list to a user specified device. In this embodiment, the controller transmits the list via an electronic mail message. The user specified device can be a data processing system, a computer, a personal digital assistant, or a wireless mobile device. In this embodiment, the product placement information includes a link to an internet address for purchasing a product presented in the media program.

The illustrative embodiments provide a mechanism for providing product placement information for a particular product presented in a media program. The product placement information provides information for a user to purchase the exact product. Additionally, the illustrative embodiments provide a mechanism for capturing the product placement information so that the user can refer to the information at a later time.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing product placement information presented in a media program, the method comprising:
receiving a request for the product placement information presented in the media program;
responsive to receiving the request, capturing a timeframe for the request for the media program, wherein a product placement information list is associated with the timeframe;
extracting the product placement information list for the timeframe from a buffer associated with the media program; and
presenting the product placement information list to a user.

2. The method of claim 1, wherein the step of presenting the product placement information list to the user comprises at least one of visually displaying the product placement information list on a media device, audibly presenting the product placement information list through the media device, and transmitting the product placement information list to a user specified device.

3. The method of claim 2, wherein the user specified device is a data processing system, a computer, a personal digital assistant, or a wireless mobile device.

4. The method of claim 3, wherein the product placement information list is transmitted using an electronic mail message.

5. The method of claim 1, wherein the product placement information list comprises at least one of a name of a manufacturer, a cost of a product, a store location to purchase the product, an internet address for the product, and an email address for the manufacturer of the product.

6. The method of claim 1, wherein the product placement information list is presented together with an image to the user.

7. The method of claim 1, wherein the request comprises an interrupt signal initiated by a predetermined set of actions.

8. The method of claim 7, wherein the predetermined set of actions comprises at least one of pressing at least one key, an audible command, and a recognizable gesture.

9. A data processing system comprising:
a user interface transmitting a request for product placement information presented in a media program;
a controller connected to the user interface, wherein the controller receives the request and captures a timeframe for the request for the media program in response to receiving the request; and
a database connected to the controller, wherein the database stores a product placement information list associated with the timeframe, and wherein the controller extracts the product placement information list for the timeframe from a buffer associated with the media program, and wherein the controller presents the product placement information list to a user.

10. The data processing system of claim 9, wherein the presentation of the product placement information list to the user comprises at least one of visually displaying the product placement information list on a media device, audibly presenting the product placement information list through the media device, and transmitting the product placement information list to a user specified device.

11. The data processing system of claim 10, wherein the user specified device is a data processing system, a computer, a personal digital assistant, or a wireless mobile device.

12. The data processing system of claim 9, wherein the product placement information list comprises at least one of a name of a manufacturer, a cost of a product, a store location to purchase the product, an internet address for the product, and an email address for the manufacturer of the product.

13. A computer program product comprising a computer usable medium including computer usable program code for providing product placement information presented in a media program, the computer program product comprising:
computer usable program code for receiving a request for the product placement information presented in the media program;
responsive to receiving the request, computer usable program code for capturing a timeframe for the request for the media program, wherein a product placement information list is associated with the timeframe;
computer usable program code for extracting the product placement information list for the timeframe from a buffer associated with the media program; and
computer usable program code for presenting the product placement information list to a user.

14. The computer program product of claim 13, wherein the computer usable program code for presenting the product placement information list to the user comprises at least one of visually displaying the product placement information list on a media device, audibly presenting the product placement information list through the media device, and transmitting the product placement information list to a user specified device.

15. The computer program product of claim 14, wherein the user specified device is a data processing system, a computer, a personal digital assistant, or a wireless mobile device.

16. The computer program product of claim 15, wherein the product placement information list is transmitted using an electronic mail message.

17. The computer program product of claim 13, wherein the product placement information list comprises at least one of a name of a manufacturer, a cost of a product, a store location to purchase the product, an internet address for the product, and an email address for the manufacturer of the product.

18. The computer program product of claim 13, wherein the product placement information list is presented together with an image to the user.

19. The computer program product of claim 13, wherein the request comprises an interrupt signal initiated by a predetermined set of actions.

20. The computer program product of claim 19, wherein the predetermined set of actions comprises at least one of pressing at least one key, an audible command, and a recognizable gesture.
